(19) United States
(12) Patent Application Publication
(10) Pub. No.: US 2014/0234038 A1
(43) Pub. Date: Aug. 21, 2014

(54) HIGH SHEAR CUTTING TOOL

(71) Applicants: David Grover Freund, Hiram, GA (US); Martin Bradley Neagu, Edwardsburg, MI (US); Gregory Edmon Privette, Villa Rica, GA (US)

(72) Inventors: David Grover Freund, Hiram, GA (US); Martin Bradley Neagu, Edwardsburg, MI (US); Gregory Edmon Privette, Villa Rica, GA (US)

(21) Appl. No.: 14/194,303

(22) Filed: Feb. 28, 2014

Related U.S. Application Data
(63) Continuation-in-part of application No. 14/133,008, filed on Dec. 18, 2013.
(60) Provisional application No. 61/748,664, filed on Jan. 3, 2013.

(51) Int. Cl. B23C 5/18; B23P 15/34

(52) U.S. Cl. CPC B23C 5/18; B23P 15/34
USPC 407/56; 76/115

(57) ABSTRACT

A high shear angle cutting tool and method of making is disclosed. A rotary cutting tool with a plurality of teeth can cause damage to a work piece during cutting. By orienting the cutting angle of the teeth relative to the rotational central axis to high shear angle such as 50 or 70 degrees, the tool creates a high compression cut which is cleaner and less damaging to the work piece.

### CROSS REFERENCE

This application claims priority of provisional application Ser. No. 61/748,664 filed 3 Jan. 2013 of the same title and is also hereby incorporated by reference in its entirety and is a CIP of Ser. No. 14/133,008 filed 18 Dec. 2013 of the same title, and which is here incorporated by reference.

### BACKGROUND

Cutting tools may be used to drill holes and cut shapes in different types of metals and woods. However, cutting tools may not always leave a clean cut and tend to leave a lot of debris, such as chips and dust, on the top and bottom of the work piece. Further, due to the low compression cut, the cutting tools cause a lot of movement of the work piece which also results in a rougher cut and surface chips on the work piece. As can be seen, there is a need for a cutting tool that provides less movement and less chipping, particularly for wood and composite materials.

### SUMMARY

This summary is intended to assist the reader in understanding the full disclosure but is not intended to limit the scope of the claims.

The present invention relates to a high shear cutting tool and, more particularly, to a high shear cutting tool.

In one embodiment a cutting device has
a cylindrical body having a central rotational axis, an outer peripheral surface and a central rotational axis and a central midline;
a plurality of cutting teeth extending from said surface including a first upper set of teeth generally on one side of the midline and a second lower set of teeth generally on the other side of the midline,
at least one of said teeth being oriented at a high shear angle relative to said axis of about 50 degrees or greater, where the upper set of teeth are oriented at a downward shear angle and the upper set of teeth are oriented at an upward shear angle.

Also disclosed is cutting tool wherein said cutting teeth are all oriented at a high shear angle of 50 degrees or greater.

Also disclosed is cutting tool wherein the teeth includes:
a. a generally vertical leading wall with a cutting edge
b. a first sloping wall abutting said cutting edge and sloping downwardly toward the central axis and away from said cutting edge.

Also disclosed is cutting tool further including a second sloping wall abutting said first sloping way and sloping downwardly toward the central axis and away from the cutting edge at an angle equal to or greater than the slope of the first wall.

Also disclosed is cutting tool wherein said first and second sloped walls are discontinuous and separated by a further connecting wall.

Also disclosed is cutting tool further including a concave section between said second wall and said base.

Also disclosed is cutting tool having
a cylindrical body having a central rotational axis, an outer peripheral surface and a central rotational axis and a central midline;
a plurality of cutting teeth extending from said surface including a first upper set of teeth generally on one side of the midline and a second lower set of teeth generally on the other side of the midline,
at least one of said teeth being oriented at a high shear angle of generally 70 degrees or greater relative to said axis.

Also disclosed is cutting tool having
a cylindrical body having a central rotational axis, an outer peripheral surface and a central rotational axis and a central midline;
a plurality of cutting teeth extending from said surface including a first upper set of teeth generally on one side of the midline and a second lower set of teeth generally on the other side of the midline,
at least one of said teeth being oriented at a high shear angle relative to said axis of about 50 degrees or greater, where the upper set of teeth are oriented at a downward shear angle and the upper set of teeth are oriented at an upward shear angle and further wherein at least one tooth includes a leading cutting edge and a wall sloping away therefrom on an edge trailing the cutting edge, to provide cutting clearance.

Also disclosed is a method of forming a clean cutting rotary tool on a cylindrical shaft comprising any or all of the following steps in any order of:
forming a plurality of teeth on the surface of the shaft
forming a leading cutting edge on the each tooth
orienting the teeth such that that are at a shear angle of 70 degrees or greater
forming a trailing edge of the teeth so that it has a first and second step back clearance wall sloping away from the leading edge, the second step having a greater clearance slope than the first step.

Also disclosed is a method further including forming a discontinuity between the first and second sloped walls.

### BRIEF DESCRIPTION OF THE DRAWINGS

FIG. 1 is a plan view of a cutting tool.

FIG. 2 is a side plan view of a second alternate cutting tool with cutting angle indicated.

FIG. 3 is a side plan view of a third alternative cutting tool with cutting angle indicated.

FIG. 4 is a side plan view of a fourth alternative cutting tool with cutting angle indicated.

FIG. 4A is a close up fragmentary view of a section of FIG. 4.

FIG. 4B is a sectional view of FIG. 4A taken along lines 4B-4B.

FIG. 4C is a view like FIG. 4B but showing a different angular dimension.

FIG. 5 is a side perspective view of a fifth alternative cutting tool.

FIG. 6 is a perspective view of the subject matter in FIG. 2.

### DETAILED DESCRIPTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

In, cutting and routing of materials, particularly fibrous materials such as wood, there is a problem of splintering at the edges. Prior attempts to solve this problem have generally been less than fully effective.

The present disclosure shows a product and method for overcoming these past problems.

Broadly, several embodiments are disclosed which provide a cutting device having a body such as of metal; a plurality of cutting teeth, an abrasive material attached to or milled from the body at the peripheral edge of the teeth and a cutting edge embedded in the abrasive material having a high edge shear angle greater. The shear angle can be greater than 50 degrees, greater than 55 degrees, greater than 60 degrees, greater than 65 degrees, greater than 70 degrees, greater than 75 degrees, greater than 80 degrees, greater than 85 degrees, or any increment therebetween such as greater than 56, 57, 58, 59 degrees (hereinafter referred to as the enhanced shear angle.

The present disclosures provides a high shear cutting tool providing a clean cut that enhances the stability of the work piece. The high shear cutting tool has a cutting angle that at an enhanced shear angle. The compression action of the high shear cutting angle pushes the cutting action into the work piece which provides a cleaner cut, better surface finish and less movement of the work piece. In effect, the cut is more akin to a punch action which creates a clean cut. The present disclosure provides a user with the ability to achieve enhanced performance by using abrasion resistant material with the high shear angles.

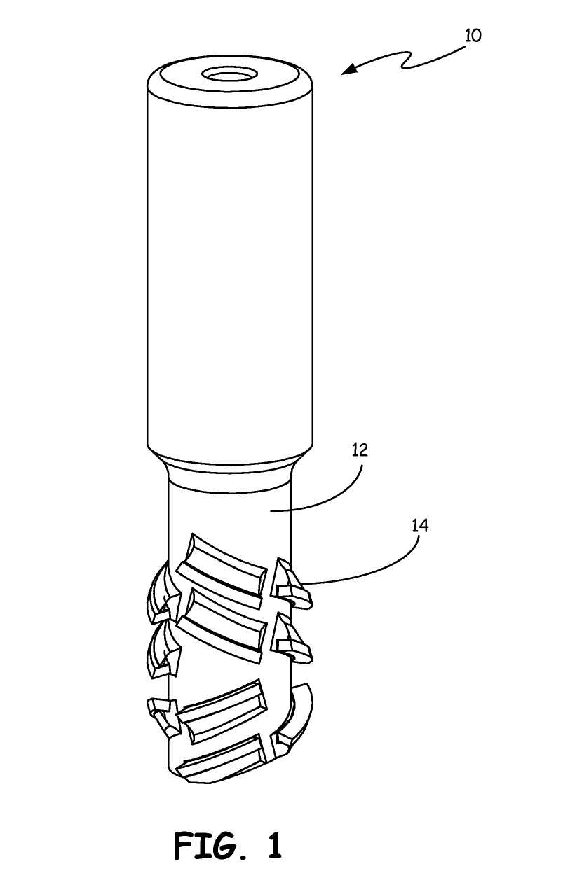

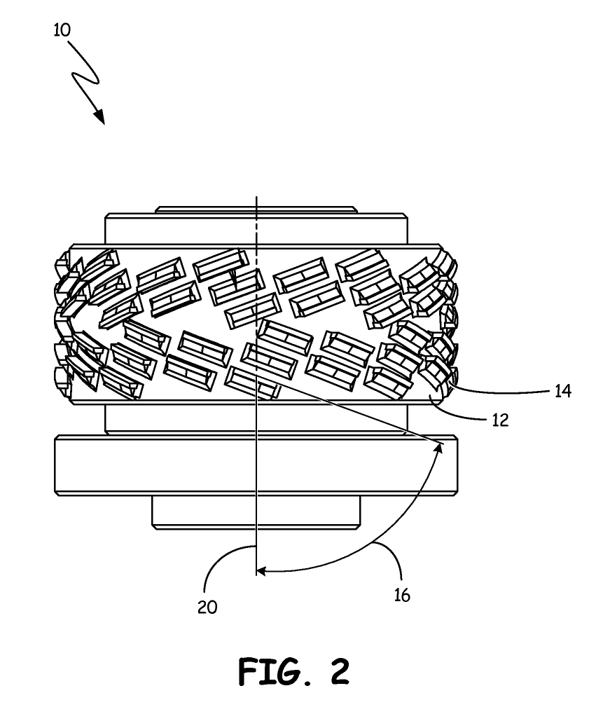

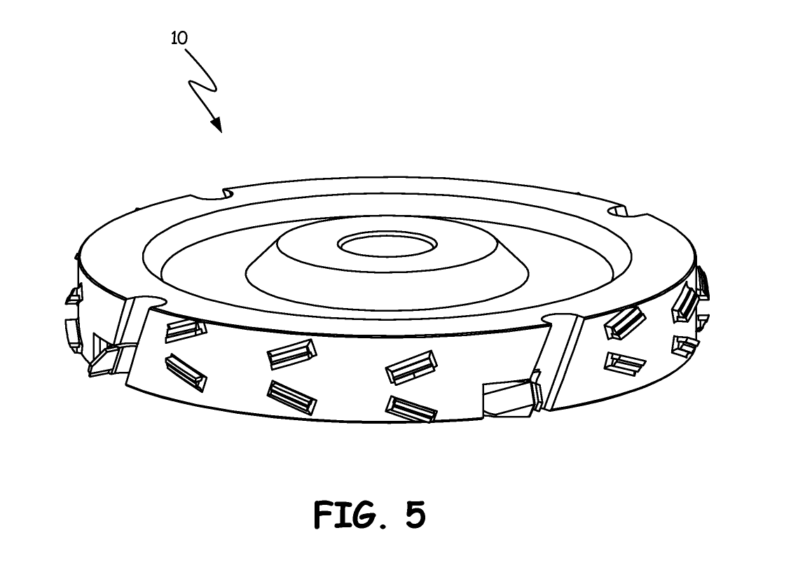

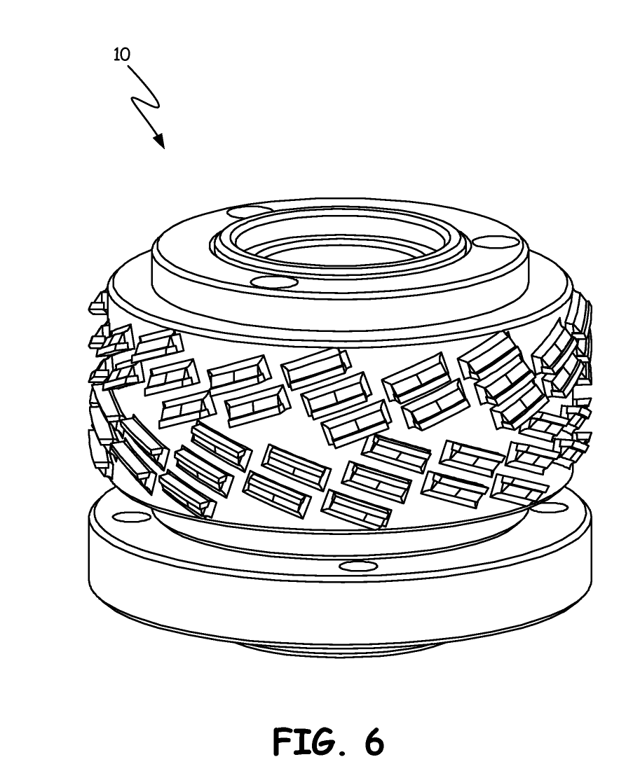

Referring now to FIGS. 1 through 6, the present invention may include a high shear cutting tool 10. The high shear cutting tool 10 may include a body 12, teeth 14 which may also have an abrasive deposited thereon, such a diamond, and a cutting edge shear angle 16. The shear angle is an industry standard term measuring the angle of the teeth 14 relative to the vertical rotational axis 20. The body 12 may be made of steel or any strong material that may be used for holding the teeth. The body 12 may provide a base for holding the abrasive material in place and provides a platform for maintaining the high shear cutting angles.

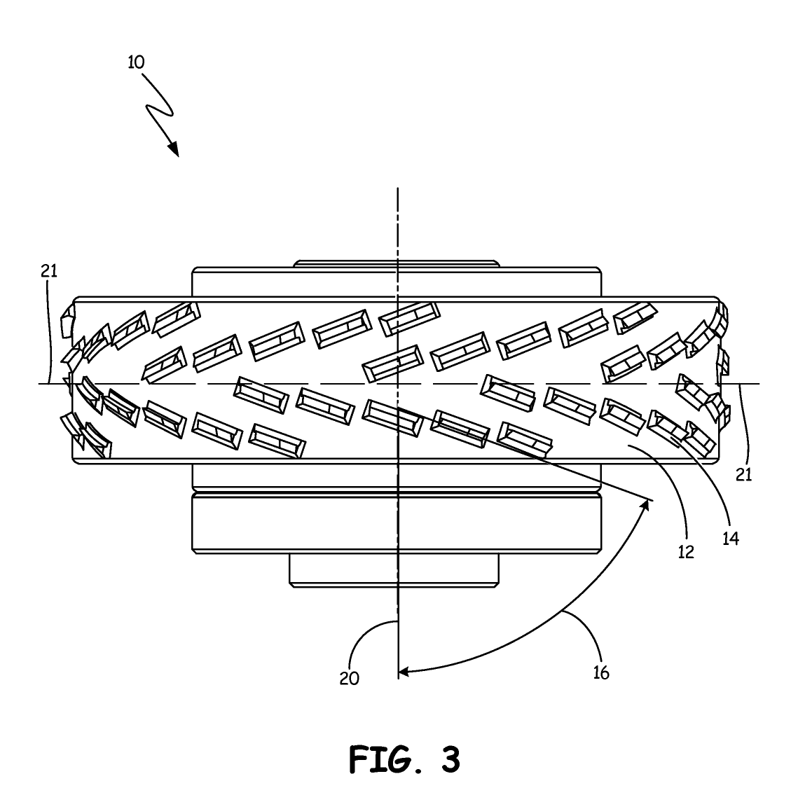

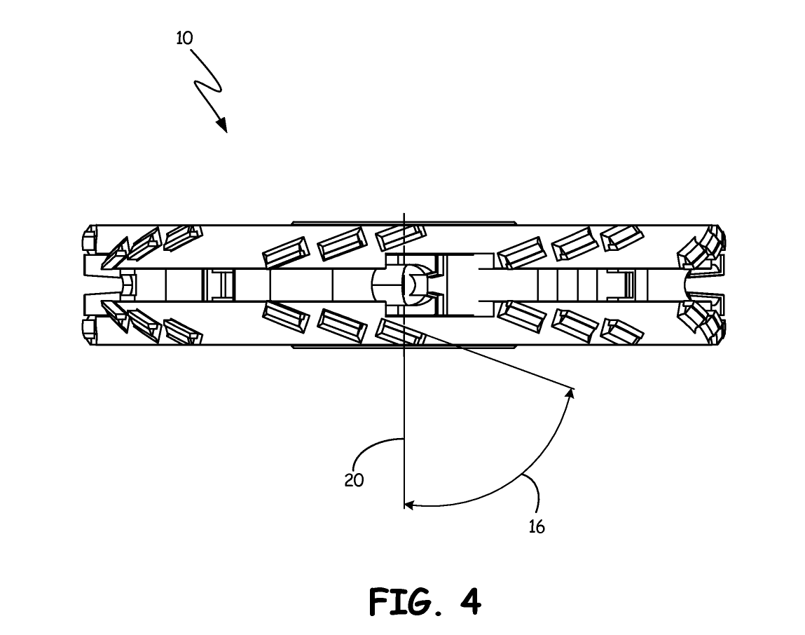

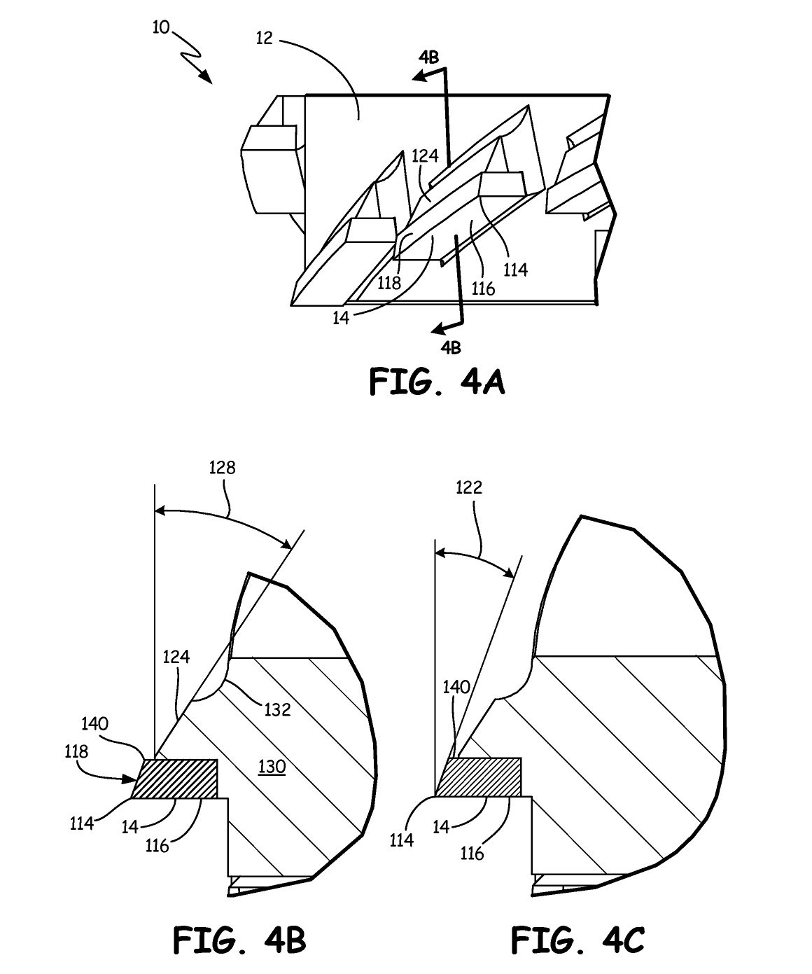

Note that the teeth 14 may be provided in two sets on either side of a center or mid-line 21 as shown in the FIG. 3. The upper teeth are angled downwardly and the lower teeth are angled upwardly, preferably at the same shear angle (although they may be different angles as needed). The teeth may intersect the line so there is no gap between teeth, or a gap may be desired as in FIG. 4, where special treatment is called for.

The abrasive material or teeth 14 may provide a wear resistant cutting edge. The abrasion resistant material 14 may be applied to the teeth such as by electrical discharge machined (EDM) to provide wear resistance. The final proper shear angle, which enables the tool to cut the work piece in a clean and chip free manner must take the abrasive into account. The cutting edge shear angle 16 may be a cutting edge with a shear angle that is at an enhanced shear angle or greater than about 50 degrees.

The proper shear angles may enable the tool to cut the work piece effectively. A variety of shear angles may be used to give different results. Further, in certain embodiments, different hook angles may also be incorporated which may enhance the performance and reduce the chipping on the top and bottom surfaces of the work piece.

In addition to the enhanced shear angle, it I may be advantageous to provide a stepped clearance angle(s) on the trailing edge of each tooth. FIG. 4A shows a tooth 14 with a leading cutting edge 114 formed by the intersection of a vertical wall 116 and a first sloped wall 118. The angle of wall 118 (shown in FIG. 4C as 122) may be from 0 degrees (flat) to approximately 35 degrees, including any of the following 5, 10, 15, 20, 25, 30, and 35 degrees in one degree increments.

In addition to this first sloped wall 118, a second sloped wall 124, adjoining 122 may be further sloped away from the first wall 118 at an angle 128 between 0-45 degrees from the vertical, or toward the central axis, (including any of the following 5, 10, 15, 20, 25, 30, 35, 40 and 45 degrees, which means it may be equal to or greater slope that the first wall.

In the preferred embodiment, the second slope is greater than the first as shown in FIGS. 4A, 4B and 4C.

Optionally, the space between the second slope 124 and the base of the tool has a convex shape 132.

There may also be a stepped region (discontinuity) 140 formed between the first and second sloped wall which offsets the first and second sloped walls by a vertical section.

Therefore a method of forming a tooth includes forming a first cutting edge with a vertical leading wall, a first sloping wall leading away from said cutting edge at a first angle and forming a second slope wall adjacent said first wall at a second angle, preferably greater than the first angle, so that the slope away from the cutting edge in increasing.

There may also be a stepped region 140 formed between the first and second sloped wall which offsets the first and second sloped walls by a vertical section.

A method of making the device may include the following.

A person may first obtain a steel tool body which incorporates the proper high shear angles, then attach an abrasion resistant material or teeth, to the steel body, and then grind or EDM the proper shear angles to enable the tool to cut the work piece in a high compression mode (i.e. at an enhanced shear angle or greater than 50 degrees). The invention may produce an end piece such as a straight or curved section made of wood, metal, plastic, or various other materials that has a smooth, clean cut, chip free surface and clean cuts on the top and bottom of the piece due to the effect of the high compression shear angles (greater than 50 degrees).

It should be understood, of course, that the foregoing relates to exemplary embodiments of the invention and that modifications may be made without departing from the spirit and scope of the invention as set forth in the following claims.

1. A cutting device comprising:
a cylindrical body having a central rotational axis, an outer peripheral surface and a central rotational axis and a central midline;
a plurality of cutting teeth extending from said surface including a first upper set of teeth generally on one side of the midline and a second lower set of teeth generally on the other side of the midline,
at least one of said teeth being oriented at a high shear angle relative to said axis of about 50 degrees or greater, where the upper set of teeth are oriented at a downward shear angle and the upper set of teeth are oriented at an upward shear angle.

2. The cutting tool of claim 1 wherein said cutting teeth are all oriented at a high shear angle of 50 degrees or greater.

3. The cutting device of claim 1 wherein at least one of said teeth includes
a. a generally vertical leading wall with a cutting edge
b. a first sloping wall abutting said cutting edge and sloping downwardly toward the central axis and away from said cutting edge.

4. The cutting device of claim 3 further including a second sloping wall abutting said first sloping way and sloping downwardly toward the central axis and away from the cutting edge at an angle equal to or greater than the slope of the first wall.

5. The cutting device of claim 4 wherein said first and second sloped walls are discontinuous and separated by a further connecting wall.

6. The cutting device of claim 4 further including a concave section between said second wall and said base.

7. A cutting device comprising:
a cylindrical body having a central rotational axis, an outer peripheral surface and a central rotational axis and a central midline;
a plurality of cutting teeth extending from said surface including a first upper set of teeth generally on one side of the midline and a second lower set of teeth generally on the other side of the midline,
at least one of said teeth being oriented at a high shear angle of generally 70 degrees or greater relative to said axis.

8. A cutting device comprising:
a cylindrical body having a central rotational axis, an outer peripheral surface and a central rotational axis and a central midline;
a plurality of cutting teeth extending from said surface including a first upper set of teeth generally on one side of the midline and a second lower set of teeth generally on the other side of the midline,
at least one of said teeth being oriented at a high shear angle relative to said axis of about 50 degrees or greater, where the upper set of teeth are oriented at a downward shear angle and the upper set of teeth are oriented at an upward shear angle and further wherein at least one tooth includes a leading cutting edge and a wall sloping away therefrom on an edge trailing the cutting edge, to provide cutting clearance.

9. A method of forming a clean cutting rotary tool on a cylindrical shaft comprising the steps of:
a. forming a plurality of teeth on the surface of the shaft
b. forming a leading cutting edge on the each tooth
c. orienting the teeth such that that are at a shear angle of 70 degrees or greater
d. forming a trailing edge of the teeth so that it has a first and second step back clearance wall sloping away from the leading edge, the second step having a greater clearance slope than the first step.

10. The method of claim 9 further including forming a discontinuity between the first and second sloped walls.
